(19) United States
(12) Patent Application Publication
(10) Pub. No.: US 2014/0267210 A1
(43) Pub. Date: Sep. 18, 2014

(54) ACTIVE CAPACITOR CIRCUIT FOR DISPLAY VOLTAGE STABILIZATION

(71) Applicant: QUALCOMM MEMS TECHNOLOGIES, INC., San Diego, CA (US)

(72) Inventors: Mark M. Todorovich, San Diego, CA (US); Alan G. Lewis, Sunnyvale, CA (US)

(73) Assignee: QUALCOMM MEMS Technologies, Inc., San Diego, CA (US)

(21) Appl. No.: 13/797,717

(22) Filed: Mar. 12, 2013

(51) Int. Cl. G09G 3/20

(52) U.S. Cl. CPC G09G 3/20
USPC 345/212; 345/55

(57) ABSTRACT

This disclosure provides systems, methods and apparatus including computer programs encoded on computer storage media for stabilization of display voltages when driving electromechanical display devices. In one aspect, a display apparatus is provided. The display apparatus includes a display array having row electrodes and column electrodes. The row electrodes are driven by a first voltage and the column electrodes are driven by a second voltage corresponding to image data. The display apparatus further includes a capacitor having a first side coupled to one or more row electrodes. The display apparatus further includes an active circuit having an output terminal coupled to a second side of the capacitor and an input terminal coupled to the one or more row electrodes. The active circuit is configured to output a base voltage applied to the second side of the capacitor.

### TECHNICAL FIELD

This disclosure relates to stabilization of display voltages when driving electromechanical display devices.

### DESCRIPTION OF THE RELATED TECHNOLOGY

Electromechanical systems (EMS) include devices having electrical and mechanical elements, actuators, transducers, sensors, optical components such as mirrors and optical films, and electronics. EMS devices or elements can be manufactured at a variety of scales including, but not limited to, microscales and nanoscales. For example, microelectromechanical systems (MEMS) devices can include structures having sizes ranging from about a micron to hundreds of microns or more. Nanoelectromechanical systems (NEMS) devices can include structures having sizes smaller than a micron including, for example, sizes smaller than several hundred nanometers. Electromechanical elements may be created using deposition, etching, lithography, and/or other micromachining processes that etch away parts of substrates and/or deposited material layers, or that add layers to form electrical and electromechanical devices.

One type of EMS device is called an interferometric modulator (IMOD). The term IMOD or interferometric light modulator refers to a device that selectively absorbs and/or reflects light using the principles of optical interference. In some implementations, an IMOD display element may include a pair of conductive plates, one or both of which may be transparent and/or reflective, wholly or in part, and capable of relative motion upon application of an appropriate electrical signal. For example, one plate may include a stationary layer deposited over, on or supported by a substrate and the other plate may include a reflective membrane separated from the stationary layer by an air gap. The position of one plate in relation to another can change the optical interference of light incident on the IMOD display element. IMOD-based display devices have a wide range of applications, and are anticipated to be used in improving existing products and creating new products, especially those with display capabilities.

### SUMMARY

The systems, methods and devices of this disclosure each have several innovative aspects, no single one of which is solely responsible for the desirable attributes disclosed herein.

One innovative aspect of the subject matter described in this disclosure can be implemented in a display apparatus. The display apparatus may include a display array including row electrodes and column electrodes, a row driver circuit configured to drive the row electrodes with a first voltage signal, a column driver circuit configured to drive the column electrodes with a second voltage signal, and at least one capacitor having a first side coupled to at least one output of the row driver circuit. At least one active circuit has an output terminal coupled to a second side of the at least one capacitor. The active circuit is configured to adjust its output at the output terminal in response to row and/or column driving activities to apply different voltages to the second side of the at least one capacitor in response to voltage transitions in the second voltage signal.

In some implementations, the apparatus can include a feedback amplifier configured to receive a reference voltage and a voltage on at least one row electrode, wherein the feedback amplifier has an output coupled to the second side of the at least one capacitor.

In some implementations, the apparatus can include a digital to analog converter having an analog output coupled to an amplifier, wherein the amplifier has an output coupled to the second side of the at least one capacitor, and wherein the apparatus includes control logic that is configured to calculate a voltage for application to the second side of the at least one capacitor, and wherein the control logic applies a digital signal to the digital to analog converter to apply the calculated voltage to the second side of the at least one capacitor.

Another innovative aspect of the subject matter described in this disclosure can be implemented in a method for operating a display apparatus including connecting a power supply output to at least one row electrode of a display array, modifying a voltage on at least one column electrode of the display array, and applying a voltage to a first side of a capacitor having a second side coupled to the power supply output. The modification may be applied in response to the modification of the voltage on the at least one column electrode.

Another innovative aspect of the subject matter described in this disclosure can be implemented in a display apparatus comprising a display array including row electrodes and column electrodes, a power supply having an output coupled to at least one row electrode of the display array, and at least one capacitor having a first side connected to the power supply output. The apparatus further includes means for modifying voltages on at least one column electrode of the display array, and means connected to the second side of the at least one capacitor for suppressing transients on the at least one row electrode.

In some implementations, the transient suppressing means includes an active circuit. In some implementations, the transient suppressing means includes a feedback amplifier having inputs connected to a row electrode and a reference voltage and an output connected to the second side of the capacitor. In some implementations, the transient suppressing means includes a digital to analog converter and an amplifier having an output connected to the second side of the capacitor. In some implementations, the display array includes interferometric modulators (IMOD).

Details of one or more implementations of the subject matter described in this disclosure are set forth in the accompanying drawings and the description below. Although the examples provided in this disclosure are primarily described in terms of EMS and MEMS-based displays the concepts provided herein may apply to other types of displays such as liquid crystal displays, organic light-emitting diode (“OLED”) displays, and field emission displays. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 is an isometric view illustration depicting two adjacent interferometric modulator (IMOD) display elements in a series or array of display elements of an IMOD display device.

FIG. 2 is a system block diagram illustrating an electronic device incorporating an IMOD-based display including a three element by three element array of IMOD display elements.

FIG. 3 is a graph illustrating movable reflective layer position versus applied voltage for an IMOD display element.

FIG. 4 is a table illustrating various states of an IMOD display element when various common and segment voltages are applied.

FIG. 5A is an illustration of a frame of display data in a three element by three element array of IMOD display elements displaying an image.

FIG. 5B is a timing diagram for common and segment signals that may be used to write data to the display elements illustrated in FIG. 5A.

FIGS. 6A and 6B are schematic exploded partial perspective views of a portion of an electromechanical systems (EMS) package including an array of EMS elements and a backplate.

FIG. 7 is an illustration of one implementation of array driver circuitry with an associated power supply.

FIG. 8 is, a schematic diagram of an implementation of the driver circuit of FIG. 7 with transient suppression capacitors.

FIG. 9 is a plot showing example voltage waveforms when driving an array of display elements according to the implementation shown in FIG. 8.

FIG. 10 is a schematic diagram of another implementation of a circuit for driving a display array while allowing the use of smaller and cheaper transient suppression capacitors.

FIG. 11 is a schematic diagram of an implementation of the active transient compensation circuit of FIG. 10 for driving a display array.

FIG. 12 is a schematic diagram of another implementation of the active transient compensation circuit of FIG. 10.

FIG. 13 is a plot showing hypothetical voltage waveforms when driving an array of display elements according to the implementation shown in FIG. 12.

FIG. 14 is a flowchart of an example of a method for operating a display apparatus while maintaining voltage stability.

FIGS. 15A and 15B are system block diagrams illustrating a display device that includes a plurality of IMOD display elements.

Like reference numbers and designations in the various drawings indicate like elements.

### DETAILED DESCRIPTION

The following description is directed to certain implementations for the purposes of describing the innovative aspects of this disclosure. However, a person having ordinary skill in the art will readily recognize that the teachings herein can be applied in a multitude of different ways. The described implementations may be implemented in any device, apparatus, or system that can be configured to display an image, whether in motion (such as video) or stationary (such as still images), and whether textual, graphical or pictorial. More particularly, it is contemplated that the described implementations may be included in or associated with a variety of electronic devices such as, but not limited to: mobile telephones, multimedia Internet enabled cellular telephones, mobile television receivers, wireless devices, smartphones, Bluetooth® devices, personal data assistants (PDAs), wireless electronic mail receivers, hand-held or portable computers, netbooks, notebooks, smartbooks, tablets, printers, copiers, scanners, facsimile devices, global positioning system (GPS) receivers/navigators, cameras, digital media players (such as MP3 players), camcorders, game consoles, wrist watches, clocks, calculators, television monitors, flat panel displays, electronic reading devices (e.g., e-readers), computer monitors, auto displays (including odometer and speedometer displays, etc.), cockpit controls and/or displays, camera view displays (such as the display of a rear view camera in a vehicle), electronic photographs, electronic billboards or signs, projectors, architectural structures, microwaves, refrigerators, stereo systems, cassette recorders or players, DVD players, CD players, VCRs, radios, portable memory chips, washers, dryers, washer/dryers, parking meters, packaging (such as in electromechanical systems (EMS) applications including microelectromechanical systems (MEMS) applications, as well as non-EMS applications), aesthetic structures (such as display of images on a piece of jewelry or clothing) and a variety of EMS devices. The teachings herein also can be used in non-display applications such as, but not limited to, electronic switching devices, radio frequency filters, sensors, accelerometers, gyroscopes, motion-sensing devices, magnetometers, inertial components for consumer electronics, parts of consumer electronics products, varactors, liquid crystal devices, electrophoretic devices, drive schemes, manufacturing processes and electronic test equipment. Thus, the teachings are not intended to be limited to the implementations depicted solely in the Figures, but instead have wide applicability as will be readily apparent to one having ordinary skill in the art.

The electrodes of the interferometric modulator (IMOD) display elements may be driven by different voltages to change the position of one electrode in relation to another. For example, voltages corresponding to image data may be driven to a first series of electrodes while a second series of electrodes is maintained at desired hold voltages to allow selectively changing of particular display element states without affecting the states of others. To prevent interference with display element operation, the voltages applied to the second series of electrodes is maintained substantially stable for a time period during which voltage transitions are being made to the first series of conductive layers. However, as the conductive layers form a capacitor structure, voltage changes according to the image data applied to the first electrodes cause voltage variations on the second electrodes. As such, a storage capacitor to damp these transients is included. The storage capacitor has a first side coupled to the second electrodes. The storage capacitor is provided to maintain the voltages applied to the second electrodes substantially stable while avoiding additional power consumption from a power supply that is applying a voltage to the second electrodes. If the storage capacitor is of a sufficient size, the voltage applied to the second electrodes may be maintained within a desired range during transitions on the first electrodes.

To reduce the size of the storage capacitor, an active circuit having an output coupled to the second side of the storage capacitor is included. The active circuit outputs a “base” voltage applied to the second side of the storage capacitor. The base voltage is at a level such that resulting charge flow between the display element and the storage capacitor causes the voltage applied to the second electrode to be maintained substantially stable. The active circuit may have an input coupled to the second electrode such that the base voltage is adjusted in response to the voltage on the second electrode. The active circuit may include a switching regulator such as a buck converter. The active circuit may adjust the base voltage applied to the second side of the storage capacitor to maintain the voltage of the second electrode substantially stable in response to changes in voltages applied to the first electrodes.

Particular implementations of the subject matter described in this disclosure can be implemented to realize one or more of the following potential advantages. Using an active circuit for applying a voltage on the second side of the storage capacitor according to the implementations described herein reduces the size of the storage capacitor. The size of the storage capacitor may be reduced while maintaining a voltage applied on the second electrodes substantially stable. Furthermore, the size and cost of the storage capacitor is reduced while ensuring power consumption used by the active circuit is not excessive. An overall reduction in one or more of capacitor size, power consumption, and transient amplitude is achievable over conventional systems without the active circuit.

An example of a suitable EMS or MEMS device or apparatus, to which the described implementations may apply, is a reflective display device. Reflective display devices can incorporate interferometric modulator (IMOD) display elements that can be implemented to selectively absorb and/or reflect light incident thereon using principles of optical interference. IMOD display elements can include a partial optical absorber, a reflector that is movable with respect to the absorber, and an optical resonant cavity defined between the absorber and the reflector. In some implementations, the reflector can be moved to two or more different positions, which can change the size of the optical resonant cavity and thereby affect the reflectance of the IMOD. The reflectance spectra of IMOD display elements can create fairly broad spectral bands that can be shifted across the visible wavelengths to generate different colors. The position of the spectral band can be adjusted by changing the thickness of the optical resonant cavity. One way of changing the optical resonant cavity is by changing the position of the reflector with respect to the absorber.

FIG. 1 is an isometric view illustration depicting two adjacent interferometric modulator (IMOD) display elements in a series or array of display elements of an IMOD display device. The IMOD display device includes one or more interferometric EMS, such as MEMS, display elements. In these devices, the interferometric MEMS display elements can be configured in either a bright or dark state. In the bright (“relaxed,” “open” or “on,” etc.) state, the display element reflects a large portion of incident visible light. Conversely, in the dark (“actuated,” “closed” or “off,” etc.) state, the display element reflects little incident visible light. MEMS display elements can be configured to reflect predominantly at particular wavelengths of light allowing for a color display in addition to black and white. In some implementations, by using multiple display elements, different intensities of color primaries and shades of gray can be achieved.

The IMOD display device can include an array of IMOD display elements which may be arranged in rows and columns. Each display element in the array can include at least a pair of reflective and semi-reflective layers, such as a movable reflective layer (i.e., a movable layer, also referred to as a mechanical layer) and a fixed partially reflective layer (i.e., a stationary layer), positioned at a variable and controllable distance from each other to form an air gap (also referred to as an optical gap, cavity or optical resonant cavity). The movable reflective layer may be moved between at least two positions. For example, in a first position, i.e., a relaxed position, the movable reflective layer can be positioned at a distance from the fixed partially reflective layer. In a second position, i.e., an actuated position, the movable reflective layer can be positioned more closely to the partially reflective layer. Incident light that reflects from the two layers can interfere constructively and/or destructively depending on the position of the movable reflective layer and the wavelength(s) of the incident light, producing either an overall reflective or non-reflective state, for each display element. In some implementations, the display element may be in a reflective state when unactuated, reflecting light within the visible spectrum, and may be in a dark state when actuated, absorbing and/or destructively interfering light within the visible range. In some other implementations, however, an IMOD display element may be in a dark state when unactuated, and in a reflective state when actuated. In some implementations, the introduction of an applied voltage can drive the display elements to change states. In some other implementations, an applied charge can drive the display elements to change states.

The depicted portion of the array in FIG. 1 includes two adjacent interferometric MEMS display elements in the form of IMOD display elements 12. In the display element 12 on the right (as illustrated), the movable reflective layer 14 is illustrated in an actuated position near, adjacent or touching the optical stack 16. The voltage V_{bias} applied across the display element 12 on the right is sufficient to move and also maintain the movable reflective layer 14 in the actuated position. In the display element 12 on the left (as illustrated), a movable reflective layer 14 is illustrated in a relaxed position at a distance (which may be predetermined based on design parameters) from an optical stack 16, which includes a partially reflective layer. The voltage Vₒ applied across the display element 12 on the left is insufficient to cause actuation of the movable reflective layer 14 to an actuated position such as that of the display element 12 on the right.

In FIG. 1, the reflective properties of IMOD display elements 12 are generally illustrated with arrows indicating light 13 incident upon the IMOD display elements 12, and light 15 reflecting from the display element 12 on the left. Most of the light 13 incident upon the display elements 12 may be transmitted through the transparent substrate 20, toward the optical stack 16. A portion of the light incident upon the optical stack 16 may be transmitted through the partially reflective layer of the optical stack 16, and a portion will be reflected back through the transparent substrate 20. The portion of light 13 that is transmitted through the optical stack 16 may be reflected from the movable reflective layer 14, back toward (and through) the transparent substrate 20. Interference (constructive and/or destructive) between the light reflected from the partially reflective layer of the optical stack 16 and the light reflected from the movable reflective layer 14 will determine in part the intensity of wavelength(s) of light 15 reflected from the display element 12 on the viewing or substrate side of the device. In some implementations, the transparent substrate 20 can be a glass substrate (sometimes referred to as a glass plate or panel). The glass substrate may be or include, for example, a borosilicate glass, a soda lime glass, quartz, Pyrex, or other suitable glass material. In some implementations, the glass substrate may have a thickness of 0.3, 0.5 or 0.7 millimeters, although in some implementations the glass substrate can be thicker (such as tens of millimeters) or thinner (such as less than 0.3 millimeters). In some implementations, a non-glass substrate can be used, such as a polycarbonate, acrylic, polyethylene terephthalate (PET) or polyether ether ketone (PEEK) substrate. In such an implementation, the non-glass substrate will likely have a thickness of less than 0.7 millimeters, although the substrate may be thicker depending on the design considerations. In some implementations, a non-transparent substrate, such as a metal foil or stainless steel-based substrate can be used. For example, a reverse-IMOD-based display, which includes a fixed reflective layer and a movable layer which is partially transmissive and partially reflective, may be configured to be viewed from the opposite side of a substrate as the display elements 12 of FIG. 1 and may be supported by a non-transparent substrate.

The optical stack 16 can include a single layer or several layers. The layer(s) can include one or more of an electrode layer, a partially reflective and partially transmissive layer, and a transparent dielectric layer. In some implementations, the optical stack 16 is electrically conductive, partially transparent and partially reflective, and may be fabricated, for example, by depositing one or more of the above layers onto a transparent substrate 20. The electrode layer can be formed from a variety of materials, such as various metals, for example indium tin oxide (ITO). The partially reflective layer can be formed from a variety of materials that are partially reflective, such as various metals (e.g., chromium and/or molybdenum), semiconductors, and dielectrics. The partially reflective layer can be formed of one or more layers of materials, and each of the layers can be formed of a single material or a combination of materials. In some implementations, certain portions of the optical stack 16 can include a single semi-transparent thickness of metal or semiconductor which serves as both a partial optical absorber and electrical conductor, while different, electrically more conductive layers or portions (e.g., of the optical stack 16 or of other structures of the display element) can serve to bus signals between IMOD display elements. The optical stack 16 also can include one or more insulating or dielectric layers covering one or more conductive layers or an electrically conductive/partially absorptive layer.

In some implementations, at least some of the layer(s) of the optical stack 16 can be patterned into parallel strips, and may form row electrodes in a display device as described further below. As will be understood by one having ordinary skill in the art, the term “patterned” is used herein to refer to masking as well as etching processes. In some implementations, a highly conductive and reflective material, such as aluminum (Al), may be used for the movable reflective layer 14, and these strips may form column electrodes in a display device. The movable reflective layer 14 may be formed as a series of parallel strips of a deposited metal layer or layers (orthogonal to the row electrodes of the optical stack 16) to form columns deposited on top of supports, such as the illustrated posts 18, and an intervening sacrificial material located between the posts 18. When the sacrificial material is etched away, a defined gap 19, or optical cavity, can be formed between the movable reflective layer 14 and the optical stack 16. In some implementations, the spacing between posts 18 may be approximately 1-1000 μm, while the gap 19 may be approximately less than 10,000 Angstroms (A).

In some implementations, each IMOD display element, whether in the actuated or relaxed state, can be considered as a capacitor formed by the fixed and moving reflective layers. When no voltage is applied, the movable reflective layer 14 remains in a mechanically relaxed state, as illustrated by the display element 12 on the left in FIG. 1, with the gap 19 between the movable reflective layer 14 and optical stack 16. However, when a potential difference, i.e., a voltage, is applied to at least one of a selected row and column, the capacitor formed at the intersection of the row and column electrodes at the corresponding display element becomes charged, and electrostatic forces pull the electrodes together. If the applied voltage exceeds a threshold, the movable reflective layer 14 can deform and move near or against the optical stack 16. A dielectric layer (not shown) within the optical stack 16 may prevent shorting and control the separation distance between the layers 14 and 16, as illustrated by the actuated display element 12 on the right in FIG. 1. The behavior can be the same regardless of the polarity of the applied potential difference. Though a series of display elements in an array may be referred to in some instances as “rows” or “columns,” a person having ordinary skill in the art will readily understand that referring to one direction as a “row” and another as a “column” is arbitrary. Restated, in some orientations, the rows can be considered columns, and the columns considered to be rows. In some implementations, the rows may be referred to as “common” lines and the columns may be referred to as “segment” lines, or vice versa. Furthermore, the display elements may be evenly arranged in orthogonal rows and columns (an “array”), or arranged in non-linear configurations, for example, having certain positional offsets with respect to one another (a “mosaic”). The terms “array” and “mosaic” may refer to either configuration. Thus, although the display is referred to as including an “array” or “mosaic,” the elements themselves need not be arranged orthogonally to one another, or disposed in an even distribution, in any instance, but may include arrangements having asymmetric shapes and unevenly distributed elements.

FIG. 2 is a system block diagram illustrating an electronic device incorporating an IMOD-based display including a three element by three element array of IMOD display elements. The electronic device includes a processor 21 that may be configured to execute one or more software modules. In addition to executing an operating system, the processor 21 may be configured to execute one or more software applications, including a web browser, a telephone application, an email program, or any other software application.

The processor 21 can be configured to communicate with an array driver 22. The array driver 22 can include a row driver circuit. 24 and a column driver circuit 26 that provide signals to, for example a display array or panel 30. The cross section of the IMOD display device illustrated in FIG. 1 is shown by the lines 1-1 in FIG. 2. Although FIG. 2 illustrates a 3×3 array of IMOD display elements for the sake of clarity, the display array 30 may contain a very large number of IMOD display elements, and may have a different number of IMOD display elements in rows than in columns, and vice versa.

FIG. 3 is a graph illustrating movable reflective layer position versus applied voltage for an IMOD display element. For IMODs, the row/column (i.e., common/segment) write procedure may take advantage of a hysteresis property of the display elements as illustrated in FIG. 3. An IMOD display element may use, in one example implementation, about a 10-volt potential difference to cause the movable reflective layer, or mirror, to change from the relaxed state to the actuated state. When the voltage is reduced from that value, the movable reflective layer maintains its state as the voltage drops back below, in this example, 10 volts, however, the movable reflective layer does not relax completely until the voltage drops below 2 volts. Thus, a range of voltage, approximately 3-7 volts, in the example of FIG. 3, exists where there is a window of applied voltage within which the element is stable in either the relaxed or actuated state. This is referred to herein as the “hysteresis window” or “stability window.” For a display array 30 having the hysteresis characteristics of FIG. 3, the row/column write procedure can be designed to address one or more rows at a time. Thus, in this example, during the addressing of a given row, display elements that are to be actuated in the addressed row can be exposed to a voltage difference of about 10 volts, and display elements that are to be relaxed can be exposed to a voltage difference of near zero volts. After addressing, the display elements can be exposed to a steady state or bias voltage difference of approximately 5 volts in this example, such that they remain in the previously strobed, or written, state. In this example, after being addressed, each display element sees a potential difference within the “stability window” of about 3-7 volts. This hysteresis property feature enables the IMOD display element design to remain stable in either an actuated or relaxed pre-existing state under the same applied voltage conditions. Since each IMOD display element, whether in the actuated or relaxed state, can serve as a capacitor formed by the fixed and moving reflective layers, this stable state can be held at a steady voltage within the hysteresis window without substantially consuming or losing power. Moreover, essentially little or no current flows into the display element if the applied voltage potential remains substantially fixed.

In some implementations, a frame of an image may be created by applying data signals in the form of “segment” voltages along the set of column electrodes, in accordance with the desired change (if any) to the state of the display elements in a given row. Each row of the array can be addressed in turn, such that the frame is written one row at a time. To write the desired data to the display elements in a first row, segment voltages corresponding to the desired state of the display elements in the first row can be applied on the column electrodes, and a first row pulse in the form of a specific “common” voltage or signal can be applied to the first row electrode. The set of segment voltages can then be changed to correspond to the desired change (if any) to the state of the display elements in the second row, and a second common voltage can be applied to the second row electrode. In some implementations, the display elements in the first row are unaffected by the change in the segment voltages applied along the column electrodes, and remain in the state they were set to during the first common voltage row pulse. This process may be repeated for the entire series of rows, or alternatively, columns, in a sequential fashion to produce the image frame. The frames can be refreshed and/or updated with new image data by continually repeating this process at some desired number of frames per second.

The combination of segment and common signals applied across each display element (that is, the potential difference across each display element or pixel) determines the resulting state of each display element. FIG. 4 is a table illustrating various states of an IMOD display element when various common and segment voltages are applied. As will be readily understood by one having ordinary skill in the art, the “segment” voltages can be applied to either the column electrodes or the row electrodes, and the “common” voltages can be applied to the other of the column electrodes or the row electrodes.

As illustrated in FIG. 4, when a release voltage VC_{REL} is applied along a common line, all IMOD display elements along the common line will be placed in a relaxed state, alternatively referred to as a released or unactuated state, regardless of the voltage applied along the segment lines, i.e., high segment voltage VS_{H} and low segment voltage VS_{L}. In particular, when the release voltage VC_{REL} is applied along a common line, the potential voltage across the modulator display elements or pixels (alternatively referred to as a display element or pixel voltage) can be within the relaxation window (see FIG. 3, also referred to as a release window) both when the high segment voltage VS_{H} and the low segment voltage VS_{L} are applied along the corresponding segment line for that display element.

When a hold voltage is applied on a common line, such as a high hold voltage VC_{HOLD}_{_{—}}_{H} or a low hold voltage VC_{HOLD}_{_{—}}_{L}, the state of the IMOD display element along that common line will remain constant. For example, a relaxed IMOD display element will remain in a relaxed position, and an actuated IMOD display element will remain in an actuated position. The hold voltages can be selected such that the display element voltage will remain within a stability window both when the high segment voltage VS_{H} and the low segment voltage VS_{L} are applied along the corresponding segment line. Thus, the segment voltage swing in this example is the difference between the high VS_{H} and low segment voltage VS_{L}, and is less than the width of either the positive or the negative stability window.

When an addressing, or actuation, voltage is applied on a common line, such as a high addressing voltage VC_{ADD}_{_{—}}_{H} or a low addressing voltage VC_{ADD}_{_{—}}_{L}, data can be selectively written to the modulators along that common line by application of segment voltages along the respective segment lines. The segment voltages may be selected such that actuation is dependent upon the segment voltage applied. When an addressing voltage is applied along a common line, application of one segment voltage will result in a display element voltage within a stability window, causing the display element to remain unactuated. In contrast, application of the other segment voltage will result in a display element voltage beyond the stability window, resulting in actuation of the display element. The particular segment voltage which causes actuation can vary depending upon which addressing voltage is used. In some implementations, when the high addressing voltage VC_{ADD}_{_{—}}_{H} is applied along the common line, application of the high segment voltage VS_{H} can cause a modulator to remain in its current position, while application of the low segment voltage VS_{L} can cause actuation of the modulator. As a corollary, the effect of the segment voltages can be the opposite when a low addressing voltage VC_{ADD}_{_{—}}_{L} is applied, with high segment voltage VS_{H} causing actuation of the modulator, and low segment voltage VS_{L} having substantially no effect (i.e., remaining stable) on the state of the modulator.

In some implementations, hold voltages, address voltages, and segment voltages may be used which produce the same polarity potential difference across the modulators. In some other implementations, signals can be used which alternate the polarity of the potential difference of the modulators from time to time. Alternation of the polarity across the modulators (that is, alternation of the polarity of write procedures) may reduce or inhibit charge accumulation that could occur after repeated write operations of a single polarity.

FIG. 5A is an illustration of a frame of display data in a three element by three element array of IMOD display elements displaying an image. FIG. 5B is a timing diagram for common and segment signals that may be used to write data to the display elements illustrated in FIG. 5A. The actuated IMOD display elements in FIG. 5A, shown by darkened checkered patterns, are in a dark-state, i.e., where a substantial portion of the reflected light is outside of the visible spectrum so as to result in a dark appearance to, for example, a viewer. Each of the unactuated IMOD display elements reflect a color corresponding to their interferometric cavity gap heights. Prior to writing the frame illustrated in FIG. 5A, the display elements can be in any state, but the write procedure illustrated in the timing diagram of FIG. 5B presumes that each modulator has been released and resides in an unactuated state before the first line time 60a.

During the first line time 60a: a release voltage 70 is applied on common line 1; the voltage applied on common line 2 begins at a high hold voltage 72 and moves to a release voltage 70; and a low hold voltage 76 is applied along common line 3. Thus, the modulators (common 1, segment 1), (1,2) and (1,3) along common line 1 remain in a relaxed, or unactuated, state for the duration of the first line time 60a, the modulators (2,1), (2,2) and (2,3) along common line 2 will move to a relaxed state, and the modulators (3,1), (3,2) and (3,3) along common line 3 will remain in their previous state. In some implementations, the segment voltages applied along segment lines 1, 2 and 3 will have no effect on the state of the IMOD display elements, as none of common lines 1, 2 or 3 are being exposed to voltage levels causing actuation during line time 60a (i.e., VC_{REL}—relax and VC_{HOLD}_{_{—}}_{L}—stable).

During the second line time 60b, the voltage on common line 1 moves to a high hold voltage 72, and all modulators along common line 1 remain in a relaxed state regardless of the segment voltage applied because no addressing, or actuation, voltage was applied on the common line 1. The modulators along common line 2 remain in a relaxed state due to the application of the release voltage 70, and the modulators (3,1), (3,2) and (3,3) along common line 3 will relax when the voltage along common line 3 moves to a release voltage 70.

During the third line time 60c, common line 1 is addressed by applying a high address voltage 74 on common line 1. Because a low segment voltage 64 is applied along segment lines 1 and 2 during the application of this address voltage, the display element voltage across modulators (1,1) and (1,2) is greater than the high end of the positive stability window (i.e., the voltage differential exceeded a characteristic threshold) of the modulators, and the modulators (1,1) and (1,2) are actuated. Conversely, because a high segment voltage 62 is applied along segment line 3, the display element voltage across modulator (1,3) is less than that of modulators (1,1) and (1,2), and remains within the positive stability window of the modulator; modulator (1,3) thus remains relaxed. Also during line time 60c, the voltage along common line 2 decreases to a low hold voltage 76, and the voltage along common line 3 remains at a release voltage 70, leaving the modulators along common lines 2 and 3 in a relaxed position.

During the fourth line time 60d, the voltage on common line 1 returns to a high hold voltage 72, leaving the modulators along common line 1 in their respective addressed states. The voltage on common line 2 is decreased to a low address voltage 78. Because a high segment voltage 62 is applied along segment line 2, the display element voltage across modulator (2,2) is below the lower end of the negative stability window of the modulator, causing the modulator (2,2) to actuate. Conversely, because a low segment voltage 64 is applied along segment lines 1 and 3, the modulators (2,1) and (2,3) remain in a relaxed position. The voltage on common line 3 increases to a high hold voltage 72, leaving the modulators along common line 3 in a relaxed state. Then, the voltage on common line 2 transitions back to the low hold voltage 76.

Finally, during the fifth line time 60e, the voltage on common line 1 remains at high hold voltage 72, and the voltage on common line 2 remains at the low hold voltage 76, leaving the modulators along common lines 1 and 2 in their respective addressed states. The voltage on common line 3 increases to a high address voltage 74 to address the modulators along common line 3. As a low segment voltage 64 is applied on segment lines 2 and 3, the modulators (3,2) and (3,3) actuate, while the high segment voltage 62 applied along segment line 1 causes modulator (3,1) to remain in a relaxed position. Thus, at the end of the fifth line time 60e, the 3×3 display element array is in the state shown in FIG. 5A, and will remain in that state as long as the hold voltages are applied along the common lines, regardless of variations in the segment voltage which may occur when modulators along other common lines (not shown) are being addressed.

In the timing diagram of FIG. 5B, a given write procedure (i.e., line times 60a-60e) can include the use of either high hold and address voltages, or low hold and address voltages. Once the write procedure has been completed for a given common line (and the common voltage is set to the hold voltage having the same polarity as the actuation voltage), the display element voltage remains within a given stability window, and does not pass through the relaxation window until a release voltage is applied on that common line. Furthermore, as each modulator is released as part of the write procedure prior to addressing the modulator, the actuation time of a modulator, rather than the release time, may determine the line time. Specifically, in implementations in which the release time of a modulator is greater than the actuation time, the release voltage may be applied for longer than a single line time, as depicted in FIG. 5A. In some other implementations, voltages applied along common lines or segment lines may vary to account for variations in the actuation and release voltages of different modulators, such as modulators of different colors.

In some implementations, the packaging of an EMS component or device, such as an IMOD-based display, can include a backplate (alternatively referred to as a backplane, back glass or recessed glass) which can be configured to protect the EMS components from damage (such as from mechanical interference or potentially damaging substances). The backplate also can provide structural support for a wide range of components, including but not limited to driver circuitry, processors, memory, interconnect arrays, vapor barriers, product housing, and the like. In some implementations, the use of a backplate can facilitate integration of components and thereby reduce the volume, weight, and/or manufacturing costs of a portable electronic device.

FIGS. 6A and 6B are schematic exploded partial perspective views of a portion of an EMS package 91 including an array 36 of EMS elements and a backplate 92. FIG. 6A is shown with two corners of the backplate 92 cut away to better illustrate certain portions of the backplate 92, while FIG. 6B is shown without the corners cut away. The EMS array 36 can include a substrate 20, support posts 18, and a movable layer 14. In some implementations, the EMS array 36 can include an array of IMOD display elements with one or more optical stack portions 16 on a transparent substrate, and the movable layer 14 can be implemented as a movable reflective layer.

The backplate 92 can be essentially planar or can have at least one contoured surface (e.g., the backplate 92 can be formed with recesses and/or protrusions). The backplate 92 may be made of any suitable material, whether transparent or opaque, conductive or insulating. Suitable materials for the backplate 92 include, but are not limited to, glass, plastic, ceramics, polymers, laminates, metals, metal foils, Kovar and plated Kovar.

As shown in FIGS. 6A and 6B, the backplate 92 can include one or more backplate components 94a and 94b, which can be partially or wholly embedded in the backplate 92. As can be seen in FIG. 6A, backplate component 94a is embedded in the backplate 92. As can be seen in FIGS. 6A and 6B, backplate component 94b is disposed within a recess 93 formed in a surface of the backplate 92. In some implementations, the backplate components 94a and/or 94b can protrude from a surface of the backplate 92. Although backplate component 94b is disposed on the side of the backplate 92 facing the substrate 20, in other implementations, the backplate components can be disposed on the opposite side of the backplate 92.

The backplate components 94a and/or 94b can include one or more active or passive electrical components, such as transistors, capacitors, inductors, resistors, diodes, switches, and/or integrated circuits (ICs) such as a packaged, standard or discrete IC. Other examples of backplate components that can be used in various implementations include antennas, batteries, and sensors such as electrical, touch, optical, or chemical sensors, or thin-film deposited devices.

In some implementations, the backplate components 94a and/or 94b can be in electrical communication with portions of the EMS array 36. Conductive structures such as traces, bumps, posts, or vias may be formed on one or both of the backplate 92 or the substrate 20 and may contact one another or other conductive components to form electrical connections between the EMS array 36 and the backplate components 94a and/or 94b. For example, FIG. 6B includes one or more conductive vias 96 on the backplate 92 which can be aligned with electrical contacts 98 extending upward from the movable layers 14 within the EMS array 36. In some implementations, the backplate 92 also can include one or more insulating layers that electrically insulate the backplate components 94a and/or 94b from other components of the EMS array 36. In some implementations in which the backplate 92 is formed from vapor-permeable materials, an interior surface of backplate 92 can be coated with a vapor barrier (not shown).

The backplate components 94a and 94b can include one or more desiccants which act to absorb any moisture that may enter the EMS package 91. In some implementations, a desiccant (or other moisture absorbing materials, such as a getter) may be provided separately from any other backplate components, for example as a sheet that is mounted to the backplate 92 (or in a recess formed therein) with adhesive. Alternatively, the desiccant may be integrated into the backplate 92. In some other implementations, the desiccant may be applied directly or indirectly over other backplate components, for example by spray-coating, screen printing, or any other suitable method.

In some implementations, the EMS array 36 and/or the backplate 92 can include mechanical standoffs 97 to maintain a distance between the backplate components and the display elements and thereby prevent mechanical interference between those components. In the implementation illustrated in FIGS. 6A and 6B, the mechanical standoffs 97 are formed as posts protruding from the backplate 92 in alignment with the support posts 18 of the EMS array 36. Alternatively or in addition, mechanical standoffs, such as rails or posts, can be provided along the edges of the EMS package 91.

Although not illustrated in FIGS. 6A and 6B, a seal can be provided which partially or completely encircles the EMS array 36. Together with the backplate 92 and the substrate 20, the seal can form a protective cavity enclosing the EMS array 36. The seal may be a semi-hermetic seal, such as a conventional epoxy-based adhesive. In some other implementations, the seal may be a hermetic seal, such as a thin film metal weld or a glass frit. In some other implementations, the seal may include polyisobutylene (PIB), polyurethane, liquid spin-on glass, solder, polymers, plastics, or other materials. In some implementations, a reinforced sealant can be used to form mechanical standoffs.

In alternate implementations, a seal ring may include an extension of either one or both of the backplate 92 or the substrate 20. For example, the seal ring may include a mechanical extension (not shown) of the backplate 92. In some implementations, the seal ring may include a separate member, such as an O-ring or other annular member.

In some implementations, the EMS array 36 and the backplate 92 are separately formed before being attached or coupled together. For example, the edge of the substrate 20 can be attached and sealed to the edge of the backplate 92 as discussed above. Alternatively, the EMS array 36 and the backplate 92 can be formed and joined together as the EMS package 91. In some other implementations, the EMS package 91 can be fabricated in any other suitable manner, such as by forming components of the backplate 92 over the EMS array 36 by deposition.

FIG. 7 is an illustration of one implementation of array driver circuitry with an associated power supply 840. In many implementations of interferometric modulator display arrays, rows of display elements are configured to reflect different colors. In the simplified array of FIG. 7, the top row 842 is a red row, the center row 844 is a green row, and the bottom row 846 is a blue row. Different color rows utilize different voltage levels for hold, actuate, etc., and so each different color row is selectively connected through a multiplexer 850 to one of the five different voltages shown in FIG. 4, where each set of five voltages may be different for each color. In many implementations, there will be hundreds or even thousands of rows of each color, each one associated with a multiplexer coupled to the set of five power supply outputs suitable for the color of that row. Because three different color rows are generally used in a color display (e.g. one third of the rows are red, one third are green, and one third are blue), each hold voltage output may be connected to about one third of the row electrodes in the array. The multiplexers 850 are controlled by timing/control logic circuitry 860, which controls the multiplexers 850 to output the appropriate voltage to each row and each column with the desired timing to produce write waveforms such as shown above in FIG. 5B to write image data to the display array.

As described above with reference to FIGS. 2-5, before image data is written to an interferometric modulator (IMOD) display element 12, a row driver circuit 24 drives row electrodes of the display panel 30 with a hold voltage 72 or 76, VC_{HOLD}_{_{—}}_{H} or VC_{HOLD}_{_{—}}_{L} (hereinafter collectively VC_{HOLD}). As an example, VC_{HOLD} may be about positive and negative 12 Volts (V), and as noted above, may vary for different color rows. While VC_{HOLD} is applied to the row electrodes, the column driver circuit 26 drives the column electrodes of the display panel with voltages VS_{H} or VS_{L} 62 or 64 corresponding to image data to be written to that row. As an example, VS_{H} and VS_{L} may be about positive or negative 2V. Thereafter, the row driver circuit 24 drives the row electrodes with VC_{ADD}_{_{—}}_{H} or VC_{ADD}_{_{—}}_{L} such that the display elements along a row selectively actuate, or are maintained in an un-actuated state depending on the total voltage across each display element 12 along that row during the application of VC_{ADD}_{_{—}}_{H} or VC_{ADD}_{_{—}}_{L}. As used herein, the term “row” is synonymous with “common line,” and receives a data independent strobing signal. The term “column” is synonymous with “segment line,” and receives a data dependent signal. The terms row and column are not intended to denote any particular geometric orientation.

As can be seen in FIG. 5B, there is a time period when the row driver circuit 24 maintains the row electrodes at VC_{HOLD} while the column driver circuit 26 changes voltages applied to the column electrodes of the display panel. See, for example, the boundary between line time 60c and 60d, where common lines 1 and 2 are at positive and negative VC_{HOLD} while segment lines 2 and 3 transition to different voltage states. Because of the capacitive coupling between the row electrodes and the column electrodes at each display element, the voltage transition applied to the column electrodes on one side of this capacitance causes voltage transients to appear on the row electrodes on the opposite side of this capacitance.

FIG. 8 is a schematic diagram of an implementation of the driver circuit of FIG. 7 with transient suppression capacitors 802 to reduce transients described above. With this circuit, voltage transients on the row electrodes are reduced using output capacitors 802 having one side coupled to each hold voltage output and the other side coupled to ground. The capacitor 802 is of a sufficient size and material such that a voltage of VC_{HOLD} is maintained within a desired tolerance on the row electrode while the driver circuit causes voltages to transition between VS_{H} and VS_{L} on the column electrode when switching the column multiplexers between states. For example, in some implementations the capacitor 802 may be a tantalum capacitor of about 20-30 μF or more.

FIG. 9 is a plot showing example voltage waveforms when driving an array of display elements according to the implementation shown in FIG. 8. The plot 900 shows voltage transients that appear at two different locations on a row electrode when the waveform 908 is applied to a set of column electrodes while the row driver circuit applies VC_{HOLD} from the power supply to a set of row electrodes. In this simple model for illustrating the transient generation, the same signal 908 is applied to all the column electrodes, and the capacitive coupling between the row electrodes and the column electrodes remains constant. When actually writing data to a display array, at a given transition time, different column electrodes may undergo different polarity transitions (or no transition), the capacitive coupling will change as the state of the display elements of the array change, and thus each transient peak amplitude may be different depending on these generally changing factors. The voltage transients of the waveforms 902 and 906 show the increased impact of column electrode transitions at the far end of the row electrode when compared to the near end of the row electrode, due to series resistance along the row electrode. The magnitude of each transient peak will depend on the capacitance of the output capacitor 802, the magnitude and polarity of the segment line transitions that occur, and the capacitive coupling between column electrodes undergoing transitions and the row electrodes coupled to the VC_{HOLD} power supply output. It is important that the voltage transients illustrated in FIG. 9 be small enough that they do not interfere with the desired actuated and/or released state of the display elements following the application of the write pulse. Accordingly, the capacitance of the capacitors 802 of FIG. 8 are selected to be large enough so that even if all the columns transition in the same direction and all the display elements coupled to the VC_{HOLD} output are in the high capacitance actuated state, the transients will still be maintained below a threshold for essentially error free data writing. In some implementations, it is desirable to use a capacitor 802 of sufficient size such that the worst case transients are limited to a maximum of about 80 mV.

While the passive capacitor circuit shown in FIG. 8 reduces transients and relaxes the peak output power requirements of the row driver circuit 24 for maintaining VC_{HOLD} during column electrode transitions, the capacitor 802 may be large and expensive. The magnitude of VC_{HOLD} is relatively large, often 15-20 V, and supplying current from the VC_{HOLD} supply uses power proportional to the square of this voltage. To minimize power losses, this capacitor 802 is of high capacitance, and the VC_{HOLD} power supply has a high output impedance to limit its current output in response to transient voltage changes on the column electrodes due to segment line transitions. Accordingly, certain aspects described herein provide different implementations for reducing the size of the capacitor 802 and while maintaining VC_{HOLD} sufficiently stable to prevent voltage variations due to column electrode transitions to interfere with display element operation and/or actuation. In one aspect, the implementations described below may be able to prevent transients substantially above 80 mV to avoid interfering with operating margins, yield, and frame rate while utilizing an output capacitor 802 of far smaller capacitance than the capacitor normally utilized to suppress transients of the same degree.

FIG. 10 is a schematic diagram of another implementation of a circuit for driving a display array while allowing the use of smaller and cheaper transient suppression capacitors 802. Similar to FIG. 8, capacitors 802 have a first side coupled to the power supply hold voltage outputs. However, rather than connecting the other side of capacitors 802 to ground as in FIG. 8, an active circuit 1002 is included having an output terminal coupled to a second side of each capacitor 802. The active circuit 1002 outputs a “base” voltage to the second side of each capacitor 802. The active circuit 1002 may receive one or more inputs from the power supply 840 or the timing/control logic 860 to generate an appropriate base voltage output with the appropriate timing. As applied to this circuit, the term “active” means it receives inputs from the display array and/or driver circuitry and is configured to adjust its output(s) in response to row and/or column driving activities which occur during the image data writing process.

Initially, prior to writing a frame or series of frames of image data, the base voltages output by the active circuit 1002 may be driven to 0 V and the capacitors 802 may be charged to the desired hold voltages for each color and polarity by the power supply 804. When writing image data, as the driver circuit transitions voltages of the column electrodes, a potentially non-zero base voltage is driven. The active circuit 1002 adjusts the base voltage to maintain the desired hold voltages on the row electrodes.

The active circuit 1002 can maintain the voltages applied to the row electrodes sufficiently stable while allowing for a relatively small size capacitor 802. As such, a smaller and less expensive capacitor 802 may be used, for example as compared to the capacitor 802 of FIG. 8. When the second side of the capacitors 802 are connected directly to ground, the size of the voltage transients is determined in part by the relative size of the capacitor 802 and the capacitance between the segment lines and the common lines connected to a given hold voltage output. With no active circuit, a 20 μF capacitor 802 may be required. With an active circuit 1002, the transients will depend on both the size of the capacitor 802, and also on the magnitudes of the voltage swings that can be applied to the second side of the capacitor. For example, in some implementations the capacitor 802 shown in FIG. 10 may be on the order of 1 μF, and the base voltages applied by the active circuit 1002 may vary between about VS_{L} and VS_{H}. Although power consumption may be higher as compared to the implementation described above with reference to FIG. 8 when a capacitor much larger than 1 μF is used, the implementation described with reference to FIG. 10 allows for decreasing the expense and physical size of the capacitor 802. Comparing the circuit of FIG. 8 with that of FIG. 10 for the same capacitor size, the power drain of the circuit is lower in the implementation of FIG. 10, as the base voltage at which current is supplied to the capacitor is much less than VC_{HOLD}, being generally between zero and VS_{L} or VS_{H}, which may be in the 1-2 V range, rather than 15-20 V range. The active circuit of FIG. 10 thus provides a way to provide an overall improvement and a better balance between the different characteristics of power draw, capacitor size, and transient amplitude as may be desired in a particular application.

FIG. 11 is a schematic diagram of an implementation of the active transient compensation circuit 1002 of FIG. 10 for driving a display array. FIG. 11 shows examples of components that may be included in the active circuit 1002 described above with reference to FIG. 10. The schematic of FIG. 11 shows only one capacitor 802. To implement the system of FIG. 10 with a circuit as illustrated in FIG. 11, the active circuit 1002 would include six separate implementations of the circuit of FIG. 11, one for each hold voltage output and corresponding capacitor.

In FIG. 11, C₁ represents the capacitance between the first column electrode and all the row electrodes that this hold voltage output is connected to (e.g., one third of the row electrodes of the array as described above), which will depend on the current actuated or released states of each display element at the intersections of the first column electrode and each row electrode this hold voltage output is connected to. The value ΔV₁ represents the magnitude of the voltage transition that the first column electrode sees during the data transition, which will depend on the voltage currently applied to the first column electrode and the voltage to be applied to the first column electrode to write the desired data. This transition may be from VS_{H} to VS_{L}, from VS_{L} to VS_{H}, or no transition may be performed on this column. The values of C₂ through Cₙ and ΔV₁ through ΔVₙ are defined similarly for column electrodes 2 through n of the display array.

The active circuit 1002 illustrated in FIG. 11 includes a feedback amplifier 1102 that may receive a target voltage V_{ref} at the positive input and the voltage on the power supply output to the row electrodes at the negative input. The amplifier will adjust the base voltage on the capacitor 802 to the level necessary to maintain the voltage on the row electrodes at V_{ref}, which may be set at the desired hold voltage VC_{HOLD} for that output. The base voltage output by the amplifier 1102 at each transition time depending on the values of C₂ through Cₙ and ΔV₁ through ΔVₙ at that transition time. The voltage V_{ref} may be generated separately by the power supply 840 or the timing/control logic, and be unaffected by any loading of other power supply outputs during the image data writing process. If the capacitance of the capacitor 802 is equal to or greater than the maximum possible sum of C₁ through Cₙ (which for many interferometric modulator display array implementaitons will be less than 2 μF, then the operational amplifier 1102 can be driven with the VS_{H} and VS_{L} power supply outputs, since the maximum required base voltage swing will be the same as the maximum transition on the column electrodes, and in most cases will be less because not all column electrodes will undergo a transition, not all display elements will be actuated.

FIG. 12 is a diagram of another implementation of the active transient compensation circuit 1002 of FIG. 10. In this implementation, the base voltage for each capacitor 802 is digitally controlled by the timing/control logic 860. In this implementation, the timing/control logic 860 computes the required base voltage adjustment that will compensate for the next transition of segment voltages in preparation for writing the next row of data. To compute this adjustment, the timing/control logic 860 determines the capacitance between the first column electrode and all the row electrodes that the hold voltage output is connected to. This is illustrated as C₁ in FIG. 12, as described above with reference to FIG. 11. This determination will depend on the actuation state of all the display elements between the first column electrode and the row electrodes the hold voltage output is connected to because the capacitance of the display elements depends on actuation state. The timing/control logic 860 may store this information as it writes data to the display array, so it can know what these states are to accurately compute this capacitance. This is repeated for each column electrode of the array, shown as C₂ through Cₙ in FIG. 12. The timing/control logic 860 may then determine the segment voltage transition that will occur at each column electrode during the next transition time. It knows this information because it knows the current state of the multiplexers 850 of FIG. 10, and it also knows the state it is going to put them in for writing the next line. The base voltage adjustment may be computed with the following formula (where Cₒ is the value of capacitor 802, and the index i runs from column electrode 1 to the last column electrode n of the array):

$$Base Voltage Adjustment = - \frac{{\sum }_{i = 1} to n Δ {V}_{i} \cdot {C}_{i}}{{C}_{0}}$$

The timing/control logic 860 adjusts its digital output to the digital to analog converter 1204 by the amount determined by this formula, which drives a buffer amplifier 1206 to set the base voltage on the capacitor 802. In some implementations, the buffer amplifier 1206 may be replaced with a hysteretic buck converter, with the output of the digital to analog converter 1204 providing the reference voltage controlling the level of the buck converter output. This may be a more energy efficient way of driving the second side of capacitor 802.

With the implementation of FIG. 12, the active circuit 1002 may control the timing of base voltage adjustments as well. For example, base voltage adjustments may be made by the timing/control logic 806 simultaneously with the application of column electrode transitions. In one aspect, applying the pulse at the time voltage transitions occur on the column electrodes may reduce the feedthrough pulse on the display elements at far ends of the row electrodes.

FIG. 13 is a plot 1300 showing modeled voltage waveforms when driving an array of display elements according to the implementation shown in FIG. 12. The plot 1300 shows voltage transients on a row electrode under the same conditions as FIG. 9. Base voltage 1310 transitions in opposite polarity to the column electrode transitions 1308. For this model, as with the model of FIG. 9, all of the column electrodes of the array are transitioned in the same direction as shown by waveform 1308. In this model, the capacitor 802 is slightly larger than the capacitive coupling between the rows and the columns, so the base voltage adjustments are smaller than the column electrode transitions. Transients in the waveforms 1302 and 1306 are reduced with respect to FIG. 9, and the capacitor 802 may still be much smaller.

FIG. 14 is a flowchart of an example of a method 1600 for operating a display apparatus while maintaining voltage stability. The method 1600 of FIG. 14 may be used in conjunction with the implementation described above with reference to FIGS. 10-12. At block 1602 a power supply output is connected to at least one row electrode of a display array. The power supply output may, for example, nominally supply a voltage of VC_{HOLD}. In one implementation, a row driver circuit applies the first voltage to a set of row electrodes. At block 1604, a voltage is modified on at least one column electrode of the display array. The voltage modification on the at least one column electrode may correspond to a transition from VS_{H} to VS_{L} or vice versa. In one implementation, a column driver circuit modifies the voltage(s) on the at least one column electrode. At block 1606, a voltage is applied to a first side of a capacitor having a second side coupled to the power supply output. The voltage is applied in response to the modification of the voltage(s) on the at least one column electrode. In one implementation, an active circuit applies the voltage to the first side of the capacitor. The voltage applied to the first side of the capacitor may depend on the polarities and magnitudes of the voltage modifications on the at least one column electrode, on the capacitive coupling between the at least one column electrode and the at least one row electrode, and on the capacitance of the capacitor.

FIGS. 15A and 15B are system block diagrams illustrating a display device 40 that includes a plurality of IMOD display elements. The display device 40 can be, for example, a smart phone, a cellular or mobile telephone. However, the same components of the display device 40 or slight variations thereof are also illustrative of various types of display devices such as televisions, computers, tablets, e-readers, hand-held devices and portable media devices.

The display device 40 includes a housing 41, a display 30, an antenna 43, a speaker 45, an input device 48 and a microphone 46. The housing 41 can be formed from any of a variety of manufacturing processes, including injection molding, and vacuum forming. In addition, the housing 41 may be made from any of a variety of materials, including, but not limited to: plastic, metal, glass, rubber and ceramic, or a combination thereof. The housing 41 can include removable portions (not shown) that may be interchanged with other removable portions of different color, or containing different logos, pictures, or symbols.

The display 30 may be any of a variety of displays, including a bi-stable or analog display, as described herein. The display 30 also can be configured to include a flat-panel display, such as plasma, EL, OLED, STN LCD, or TFT LCD, or a non-flat-panel display, such as a CRT or other tube device. In addition, the display 30 can include an IMOD-based display, as described herein.

The components of the display device 40 are schematically illustrated in FIG. 15A. The display device 40 includes a housing 41 and can include additional components at least partially enclosed therein. For example, the display device 40 includes a network interface 27 that includes an antenna 43 which can be coupled to a transceiver 47. The network interface 27 may be a source for image data that could be displayed on the display device 40. Accordingly, the network interface 27 is one example of an image source module, but the processor 21 and the input device 48 also may serve as an image source module. The transceiver 47 is connected to a processor 21, which is connected to conditioning hardware 52. The conditioning hardware 52 may be configured to condition a signal (such as filter or otherwise manipulate a signal). The conditioning hardware 52 can be connected to a speaker 45 and a microphone 46. The processor 21 also can be connected to an input device 48 and a driver controller 29. The driver controller 29 can be coupled to a frame buffer 28, and to an array driver 22, which in turn can be coupled to a display array 30. One or more elements in the display device 40, including elements not specifically depicted in FIG. 17A, can be configured to function as a memory device and be configured to communicate with the processor 21. In some implementations, a power supply 50 can provide power to substantially all components in the particular display device 40 design.

The network interface 27 includes the antenna 43 and the transceiver 47 so that the display device 40 can communicate with one or more devices over a network. The network interface 27 also may have some processing capabilities to relieve, for example, data processing requirements of the processor 21. The antenna 43 can transmit and receive signals. In some implementations, the antenna 43 transmits and receives RF signals according to the IEEE 16.11 standard, including IEEE 16.11(a), (b), or (g), or the IEEE 802.11 standard, including IEEE 802.11a, b, g, n, and further implementations thereof. In some other implementations, the antenna 43 transmits and receives RF signals according to the Bluetooth® standard. In the case of a cellular telephone, the antenna 43 can be designed to receive code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband CDMA (W-CDMA), Evolution Data Optimized (EV-DO), 1xEV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless network, such as a system utilizing 3G, 4G or 5G technology. The transceiver 47 can pre-process the signals received from the antenna 43 so that they may be received by and further manipulated by the processor 21. The transceiver 47 also can process signals received from the processor 21 so that they may be transmitted from the display device 40 via the antenna 43.

In some implementations, the transceiver 47 can be replaced by a receiver. In addition, in some implementations, the network interface 27 can be replaced by an image source, which can store or generate image data to be sent to the processor 21. The processor 21 can control the overall operation of the display device 40. The processor 21 receives data, such as compressed image data from the network interface 27 or an image source, and processes the data into raw image data or into a format that can be readily processed into raw image data. The processor 21 can send the processed data to the driver controller 29 or to the frame buffer 28 for storage. Raw data typically refers to the information that identifies the image characteristics at each location within an image. For example, such image characteristics can include color, saturation and gray-scale level.

The processor 21 can include a microcontroller, CPU, or logic unit to control operation of the display device 40. The conditioning hardware 52 may include amplifiers and filters for transmitting signals to the speaker 45, and for receiving, signals from the microphone 46. The conditioning hardware 52 may be discrete components within the display device 40, or may be incorporated within the processor 21 or other components.

The driver controller 29 can take the raw image data generated by the processor 21 either directly from the processor 21 or from the frame buffer 28 and can re-format the raw image data appropriately for high speed transmission to the array driver 22. In some implementations, the driver controller 29 can re-format the raw image data into a data flow having a raster-like format, such that it has a time order suitable for scanning across the display array 30. Then the driver controller 29 sends the formatted information to the array driver 22. Although a driver controller 29, such as an LCD controller, is often associated with the system processor 21 as a stand-alone Integrated Circuit (IC), such controllers may be implemented in many ways. For example, controllers may be embedded in the processor 21 as hardware, embedded in the processor 21 as software, or fully integrated in hardware with the array driver 22.

The array driver 22 can receive the formatted information from the driver controller 29 and can re-format the video data into a parallel set of waveforms that are applied many times per second to the hundreds, and sometimes thousands (or more), of leads coming from the display's x-y matrix of display elements.

In some implementations, the driver controller 29, the array driver 22, and the display array 30 are appropriate for any of the types of displays described herein. For example, the driver controller 29 can be a conventional display controller or a bi-stable display controller (such as an IMOD display element controller). Additionally, the array driver 22 can be a conventional driver or a bi-stable display driver (such as an IMOD display element driver). Moreover, the display array 30 can be a conventional display array or a bi-stable display array (such as a display including an array of IMOD display elements). In some implementations, the driver controller 29 can be integrated with the array driver 22. Such an implementation can be useful in highly integrated systems, for example, mobile phones, portable-electronic devices, watches or small-area displays.

In some implementations, the input device 48 can be configured to allow, for example, a user to control the operation of the display device 40. The input device 48 can include a keypad, such as a QWERTY keyboard or a telephone keypad, a button, a switch, a rocker, a touch-sensitive screen, a touch-sensitive screen integrated with the display array 30, or a pressure- or heat-sensitive membrane. The microphone 46 can be configured as an input device for the display device 40. In some implementations, voice commands through the microphone 46 can be used for controlling operations of the display device 40.

The power supply 50 can include a variety of energy storage devices. For example, the power supply 50 can be a rechargeable battery, such as a nickel-cadmium battery or a lithium-ion battery. In implementations using a rechargeable battery, the rechargeable battery may be chargeable using power coming from, for example, a wall socket or a photovoltaic device or array. Alternatively, the rechargeable battery can be wirelessly chargeable. The power supply 50 also can be a renewable energy source, a capacitor, or a solar cell, including a plastic solar cell or solar-cell paint. The power supply 50 also can be configured to receive power from a wall outlet.

In some implementations, control programmability resides in the driver controller 29 which can be located in several places in the electronic display system. In some other implementations, control programmability resides in the array driver 22. The above-described optimization may be implemented in any number of hardware and/or software components and in various configurations.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logics, logical blocks, modules, circuits and algorithm steps described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and steps described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some implementations, particular steps and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein. Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of, e.g., an IMOD display element as implemented.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, a person having ordinary skill in the art will readily recognize that such operations need not be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

What is claimed is:

1. A display apparatus comprising:
a display array including row electrodes and column electrodes;
a row driver circuit configured to drive the row electrodes with a first voltage signal;
a column driver circuit configured to drive the column electrodes with a second voltage signal;
at least one capacitor having a first side coupled to at least one output of the row driver circuit; and
at least one active circuit having an output terminal coupled to a second side of the at least one capacitor, the active circuit configured to adjust its output at the output terminal in response to row and/or column driving activities to apply different voltages to the second side of the at least one capacitor in response to voltage transitions in the second voltage signal.

2. The display apparatus of claim 1, wherein the active circuit includes:
a feedback amplifier configured to receive a reference voltage and a voltage on at least one row electrode, wherein the feedback amplifier has an output coupled to the second side of the at least one capacitor.

3. The display apparatus of claim 1, wherein active circuit adjusts the base voltage applied to the second side of the capacitor to maintain the voltage on the row electrode close to a reference voltage.

4. The display apparatus of claim 2, wherein the reference voltage is at a level configured to maintain the display element in a selected state.

5. The display apparatus of claim 1, wherein the active circuit includes a digital to analog converter having an analog output coupled to an amplifier, wherein the amplifier has an output coupled to the second side of the at least one capacitor, and wherein the apparatus includes control logic that is configured to calculate a voltage for application to the second side of the at least one capacitor, and wherein the control logic applies a digital signal to the digital to analog converter to apply the calculated voltage to the second side of the at least one capacitor.

6. The display apparatus of claim 1, wherein the display array includes interferometric modulators (IMOD).

7. The display apparatus of claim 1, further comprising:
a processor that is configured to communicate with the display array, the processor being configured to process the image data; and
a memory device that is configured to communicate with the processor.

8. The apparatus of claim 7, further comprising:
a driver circuit configured to send at least one signal to the display array; and
a controller configured to send at least a portion of the image data to the driver circuit.

9. The apparatus of claim 7, further comprising:
an image source module configured to send the image data to the processor, wherein the image source module includes at least one of a receiver, transceiver, and transmitter.

10. The apparatus of claim 7, further comprising:
an input device configured to receive input data and to communicate the input data to the processor.

11. A method for operating a display apparatus comprising:
connecting a power supply output to at least one row electrode of a display array;
modifying a voltage on at least one column electrode of the display array; and
applying a voltage to a first side of a capacitor having a second side coupled to the power supply output, the modification being applied in response to the modification of the voltage on the at least one column electrode.

12. The method of claim 11, further including:
receiving a reference voltage and the voltage on the at least one row electrode as inputs to a feedback amplifier;
generating the voltage on the first side of the capacitor based at least in part on the output of the feedback amplifier.

13. The method of claim 11, including applying the voltage on the first side of the capacitor with an active circuit.

14. The method of claim 11, including calculating a voltage to apply to the first side of the at least one capacitor, wherein the calculating is based at least in part on the voltage modification on the at least one column electrode, the state of at least some display elements of the display apparatus, and the capacitance of the capacitor.

15. The method of claim 12, wherein the reference voltage is at a level configured to maintain the display element in a selected state.

16. A display apparatus comprising:
a display array including row electrodes and column electrodes;
a power supply having an output coupled to at least one row electrode of the display array;
at least one capacitor having a first side connected to the power supply output;
means for modifying voltages on at least one column electrode of the display array; and
means connected to the second side of the at least one capacitor for suppressing transients on the at least one row electrode.

17. The display apparatus of claim 16, wherein the transient suppressing means includes an active circuit.

18. The display apparatus of claim 16, wherein the transient suppressing means includes a feedback amplifier having inputs connected to a row electrode and a reference voltage and an output connected to the second side of the capacitor.

19. The display apparatus of claim 16, wherein the transient suppressing means includes a digital to analog converter and an amplifier having an output connected to the second side of the capacitor.

20. The display apparatus of claim 16, wherein the display array includes interferometric modulators (IMOD).
